(19) United States
(12) Patent Application Publication
(10) Pub. No.: US 2026/0032426 A1
(43) Pub. Date: Jan. 29, 2026

(54) METHOD AND APPARATUS FOR INDICATION OF ARTIFICIAL INTELLIGENCE AND MACHINE LEARNING CAPABILITY

(71) Applicant: Samsung Electronics Co., Ltd., Suwon-si, Gyeonggi-do (KR)

(72) Inventors: Chadi KHIRALLAH, Staines (GB); David GUTIERREZ ESTEVEZ, Staines (GB); Mahmoud WATFA, Staines (GB)

(21) Appl. No.: 18/881,562

(22) PCT Filed: Jul. 4, 2023
(86) PCT No.: PCT/KR2023/009429

§ 371 Date: Jan. 6, 2025

(30) Foreign Application Priority Data
Jul. 6, 2022 (CN) 2209921.2
Jun. 15, 2023 (CN) 2308976.6

(51) Int. Cl. H04W 8/22; H04W 64/00; H04W 76/20

(52) U.S. Cl. CPC H04W 8/22; H04W 64/00; H04W 76/20

(57) ABSTRACT

The disclosure relates to a 5G or 6G communication system for supporting a higher data transmission rate. There is disclosed a first method for reporting user equipment (UE) artificial intelligence (AI)/machine learning (ML) capability to a network. The first method comprises: transmitting, to the network, an indication of the UE AI/ML capability. There is also disclosed a second method for reporting network AI/ML capability to a UE. The second method comprises: transmitting, to the UE, an indication of the network AI/ML capability.

### CROSS-REFERENCE TO RELATED APPLICATION(S)

This application is a U.S. National Stage application under 35 U.S.C. § 371 of an International application number PCT/KR2023/009429, filed on Jul. 4, 2023, which is based on and claims priority of a Chinese patent application number 2209921.2, filed on Jul. 6, 2022, in the Chinese Intellectual Property Office, and of a Chinese patent application number 2308976.6, filed on Jun. 15, 2023, in the Chinese Intellectual Property Office, the disclosure of each of which is incorporated by reference herein in its entirety.

### TECHNICAL FIELD

Embodiments of the present disclosure provide one or more techniques for Artificial Intelligence (AI) and/or Machine Leaning (ML) capability indication.

### BACKGROUND ART

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

What is desired is one or more techniques for Artificial Intelligence (AI) and/or Machine Leaning (ML) capability indication.

The above information is presented as background information only to assist with an understanding of the present disclosure. No determination has been made, and no assertion is made, as to whether any of the above might be applicable as prior art with regard to the present invention.

### DISCLOSURE OF INVENTION

### Solution to Problem

Embodiments of the present disclosure provide methods, apparatus and systems for indicating UE capability of AI/ML to a 3rd Generation Partnership Project (3GPP) 5-th Generation (5G) network and/or for indicating network AI/ML capability to the UE.

Embodiments of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

Embodiments or examples disclosed in the description and/or figures falling outside the scope of the claims are to be understood as examples useful for understanding the present invention.

Other aspects, advantages and salient features of the disclosure will become apparent to those skilled in the art from the following detailed description taken in conjunction with the accompanying drawings.

### BRIEF DESCRIPTION OF DRAWINGS

Embodiments disclosed herein are illustrated in the accompanying drawings, throughout which like reference letters indicate corresponding parts in the various figures. The embodiments herein will be better understood from the following description with reference to the drawings, in which:

FIG. 1 illustrates two solutions for providing UE AI/ML capability indication to the network;

FIG. 2 illustrates a procedure of including UE capability indication in a message according to embodiments of the present disclosure;

FIG. 3 illustrates a procedure of providing UE capability indication to the network in a RRC and NG signalling/messages according to embodiments of the present disclosure; and

FIG. 4 is a block diagram of an exemplary network entity that may be used in embodiments of the present disclosure.

### MODE FOR THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

Certain examples of the present disclosure provide one or more techniques for Artificial Intelligence (AI) and/or Machine Leaning (ML) capability indication. For example, certain examples of the present disclosure provide methods, apparatus and systems for indicating UE capability of AI/ML to a 3rd Generation Partnership Project (3GPP) 5th Generation (5G) network and/or for indicating network AI/ML capability to the UE. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The following examples are applicable to, and use terminology associated with, 3GPP 5G. However, as noted above the skilled person will appreciate that the techniques disclosed herein are not limited to 3GPP 5G. For example, the functionality of the various network entities and other features disclosed herein may be applied to corresponding or equivalent entities or features in other communication systems or standards. Corresponding or equivalent entities or features may be regarded as entities or features that perform the same or similar role, function or purpose within the network. For example, the functionality of the AMF, SMF, NWDAF and/or AI/ML NF in the examples below may be applied to any other suitable types of entities respectively providing an access and mobility function, a session management function, network analytics and/or an AI/ML function.

The skilled person will appreciate that the present invention is not limited to the specific examples disclosed herein. For example:
One or more entities in the examples disclosed herein may be replaced with one or more alternative entities performing equivalent or corresponding functions, processes or operations;
One or more of the messages in the examples disclosed herein may be replaced with one or more alternative types or forms of messages, signals or other type of information carriers that communicate equivalent or corresponding information;
One or more further entities and/or messages may be added to the examples disclosed herein;
One or more non-essential entities and/or messages may be omitted in certain examples;
The functions, processes or operations of a particular entity in one example may be divided between two or more separate entities in an alternative example;
The functions, processes or operations of two or more separate entities in one example may be performed by a single entity in an alternative example;
Information carried by a particular message in one example may be carried by two or more separate messages in an alternative example;
Information carried by two or more separate messages in one example may be carried by a single message in an alternative example; and/or
The order in which operations are performed and/or the order in which messages are transmitted may be modified, if possible, in alternative examples.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

A particular network entity may be implemented as a network element on a dedicated hardware, as a software instance running on a dedicated hardware, and/or as a virtualised function instantiated on an appropriate platform, e.g. on a cloud infrastructure.

In the present disclosure, a UE may refer to one or both of mobile termination (MT) and terminal equipment (TE). MT may offer common mobile network functions, for example one or more of radio transmission and handover, speech encoding and decoding, error detection and correction, signalling and access to a SIM (subscriber identity module). An IMEI (international mobile equipment identity) code, or any other suitable type of identity, may attached to the MT. TE may offer any suitable services to the user via MT functions. However, it may not contain any network functions itself.

Herein, the following documents may be referenced:
[1] RP-213599, Study on Artificial Intelligence (AI)/Machine Learning (ML) for NR Air Interface;
[2] 3GPP TS 38.413, Technical Specification Group Radio Access Network; NG-RAN; NG Application Protocol (NGAP) (Release 17);
[3] 3GPP TS 38.331, Technical Specification Group Radio Access Network; NR; Radio Resource Control (RRC) protocol specification (Release 17); and/or
[4] 3GPP TS 23.501.

Various acronyms, abbreviations and definitions used in the present disclosure are defined at the end of this description.

AI/ML is being used in a range of application domains across industry sectors. In mobile communications systems, conventional algorithms (e.g. speech recognition, image recognition, video processing) in mobile devices (e.g. smartphones, automotive, robots) are being increasingly replaced with AI/ML models to enable various applications.

The 5G system can support various types of AI/ML operations, in including the following three defined in 3GPP TS 22.261:
AI/ML operation splitting between AI/ML endpoints

The AI/ML operation/model may be split into multiple parts, for example according to the current task and environment. The intention is to offload the computation-intensive, energy-intensive parts to network endpoints, and to leave the privacy-sensitive and delay-sensitive parts at the end device. The device executes the operation/model up to a specific part/layer and then sends the intermediate data to the network endpoint. The network endpoint executes the remaining parts/layers and feeds the inference results back to the device.
AI/ML model/data distribution and sharing over 5G system

Multi-functional mobile terminals may need to switch an AI/ML model, for example in response to task and environment variations. An assumption of adaptive model selection is that the models to be selected are available for the mobile device. However, since AI/ML models are becoming increasingly diverse, and with the limited storage resource in a UE, not all candidate AI/ML models may be pre-loaded on-board. Online model distribution (i.e. new model downloading) may be needed, in which an AI/ML model can be distributed from a Network (NW) endpoint to the devices when they need it to adapt to the changed AI/ML tasks and environments. For this purpose, the model performance at the UE may need to be monitored constantly.
Distributed/Federated Learning over 5G system

A cloud server may train a global model by aggregating local models partially-trained by each of a number of end devices e.g. UEs). Within each training iteration, a UE performs the training based on a model downloaded from the AI server using local training data. Then the UE reports the interim training results to the cloud server, for example via 5G UL channels. The server aggregates the interim training results from the UEs and updates the global model. The updated global model is then distributed back to the UEs and the UEs can perform the training for the next iteration.

There is an ongoing study in 3GPP RAN groups on the topic of AI/ML where the objectives of the “Study on Artificial Intelligence (AI)/Machine Learning (ML) for NR Air Interface” [1] are as follows:

Study the 3GPP framework for AI/ML for air-interface corresponding to each target use case regarding aspects such as performance, complexity, and potential specification impact.

Use cases to focus on:
Initial set of use cases includes:
   CSI feedback enhancement, e.g., overhead reduction, improved accuracy, prediction [RAN1]
   Beam management, e.g., beam prediction in time, and/or spatial domain for overhead and latency reduction, beam selection accuracy improvement [RAN1]
   Positioning accuracy enhancements for different scenarios including, e.g., those with heavy NLOS conditions [RAN1]
Finalize representative sub use cases for each use case for characterization and baseline performance evaluations by RAN #98
   The AI/ML approaches for the selected sub use cases need to be diverse enough to support various requirements on the gNB-UE collaboration levels
[ . . . ]
   Protocol aspects, e.g., (RAN2)-RAN2 only starts the work after there is sufficient progress on the use case study in RAN1

Consider aspects related to, e.g., capability indication, configuration and control procedures (training/inference), and management of data and AI/ML model, per RAN1 input

### Collaboration Level Specific Specification Impact Per Use Case

Interoperability and testability aspects, e.g., (RAN4)-RAN4 only starts the work after there is sufficient progress on use case study in RAN1 and RAN2

Requirements and testing frameworks to validate AI/ML based performance enhancements and ensuring that UE and gNB with AI/ML meet or exceed the existing minimum requirements if applicable

### Consider the Need and Implications for AI/ML Processing Capabilities Definition

Note 1: specific AI/ML models are not expected to be specified and are left to implementation. User data privacy needs to be preserved.
Note 2: The study on AI/ML for air interface is based on the current RAN architecture and new interfaces shall not be introduced.

AI/ML Application may be part of TE using the services offered by MT in order to support AI/ML operation, whereas AI/ML Application Client may be part of MT. Alternatively, part of AI/ML Application client may be in TE and a part of AI/ML application client may be in MT.

The procedures disclosed herein may refer to various network functions/entities. Various functions and definitions of certain network functions/entities, for example those indicated below, may be known to the skilled person, and are defined, for example, in at least 3GPP 23.501 and 3GPP TS 23.502:
Application Function: AF
Network Exposure Function: NEF
Unified Data Management: UDM
Unified Data Repository: UDR
Network Function: NF
Access and Mobility Function: AMF
Session Management Function: SMF
Network Data Analytics Function: NWDAF
(Radio) Access Network: (R) AN
User Equipment: UE

However, as noted above, the skilled person will appreciate that the present disclosure is not limited to the definitions given in 3GPP 23.501 and 3GPP TS 23.502, and that equivalent functions/entities may be used.

As noted above, what is desired is one or more techniques for AI and/or ML capability indication (e.g. reporting UE and Network AI/ML Capability).

For example, certain examples of the present disclosure address one or more of the following questions:
Q1. How to indicate UE capability of AI/ML to the network (e.g. RAN, CN, another internal and/or external network entity, and/or network function).
Q2. How to indicate network AI/ML capability to the UE (and/or other network entities and/or functions).

Reporting UE AI/ML Capability: Section 1 below discloses one or more techniques for addressing question Q1 above.

Reporting Network AI/ML Capability to the UE: Section 2 below discloses one or more techniques for addressing question Q2 above.

Certain examples of the present disclosure provide a method for reporting User Equipment (UE) Artificial Intelligence (AI)/Machine Learning (ML) capability to a network, the method comprising: transmitting, to the network, an indication of the UE AI/ML capability.

In certain examples, the indication may be transmitted to one or more of: a RAN node (e.g. NG-RAN, gNB and/or eNB); and a Core Network (CN) entity (e.g. AMF and/or LMF).

In certain examples, the indication may be transmitted to a RAN node (e.g. using RRC (radio resource control) signalling), and forwarded by the RAN node to a CN entity (e.g. using NG (NR (new radio) generation) signalling).

In certain examples, the method may further comprise forwarding, by a first network entity (e.g. AMF), to a second network entity (e.g. LMF and/or SMF), the indication.

In certain examples, the indication may be transmitted or forwarded using an Information Element (IE) (e.g. a new and/or existing IE, UE AI/ML Capability IE, UE AI/ML Capability Indication IE, IE included in a UE RADIO CAPABILITY INFO INDICATION message, and/or IE included in an NG message).

In certain examples, the method may further comprise transmitting (e.g. as part of the indication (e.g. in an IE of a UE capability indication message)), to the network, information (e.g. model ID(s)) relating to one or more requested, supported and/or available models, and/or information relating to one or more model operations (e.g. training, inference, monitoring, other).

In certain examples, the indication may indicate one or more of: generic AI/ML capability (e.g. an indication that the UE can perform AI/ML operations); per use case AI/ML capability; per service AI/ML capability (e.g. an indication that the UE can use AI/ML for positioning accuracy); and per AI/ML operation capability.

In certain examples, the indication may indicate that the UE can perform one or more of: training; inference; monitoring; selection; switching; and an operation related to model management.

In certain examples, the indication may be transmitted and/or forwarded using one or more of: Non Access Stratum (NAS) signalling; and Radio Resource Control (RRC) signalling and/or messages.

Certain examples of the present disclosure provide a method for reporting network Artificial Intelligence (AI)/Machine Learning (ML) capability to a User Equipment (UE), the method comprising: transmitting, to the UE, an indication of the network AI/ML capability.

In certain examples, the indication may be transmitted by one or more of: a RAN node (e.g. NG-RAN, gNB and/or eNB); and a Core Network (CN) entity (e.g. AMF and/or LMF).

In certain examples, the indication may indicate one or more of: generic AI/ML capability (e.g. an indication that the network supports AI/ML operations); a list of supported and/or available AI/ML models in the network; information (e.g. model ID(s)) related to one or more AI/ML models and/or one or more AI/ML operations in the network (e.g. whether a model is ready for inference or requires training and/or monitoring); per AI/ML operation capability; and per use case AI/ML capability.

In certain examples, the indication may be transmitted using one or more of: NAS signalling (e.g. from a CN entity other than LMF); and LTE Positioning Protocol (LPP) signalling towards the UE (e.g. from LMF).

In certain examples, the indication may be transmitted using one or more of: dedicated signalling; an Information Element (IE) (e.g. a new and/or existing IE included in an RRC message); and System Information Broadcast (e.g. periodically and/or on-demand).

In certain examples, the method may further comprise: broadcasting, as part of system information (e.g. in a SIB), by each cell of a serving RAN node, an indication (e.g. a flag) that the RAN node supports AI/ML operation.

In certain examples, the capability (e.g. UE and/or network capability) may be an existing capability and/or a newly defined capability.

Certain examples of the present disclosure provide a UE configured to perform a method according to any example, embodiment, aspect and/or claim disclosed herein.

Certain examples of the present disclosure provide a network entity (e.g. RAN node and/or CN entity) configured to perform a method according to any example, embodiment, aspect and/or claim disclosed herein.

Certain examples of the present disclosure provide a network (or wireless communication system) comprising a UE according to any example, embodiment, aspect and/or claim disclosed herein; and a network entity according to any example, embodiment, aspect and/or claim disclosed herein.

Certain examples of the present disclosure provide a computer program comprising instructions which, when the program is executed by a computer or processor, cause the computer or processor to carry out a method according to any example, embodiment, aspect and/or claim disclosed herein.

Certain examples of the present disclosure provide a computer or processor-readable data carrier having stored thereon a computer program according to any example, embodiment, aspect and/or claim disclosed herein.

The skilled person will appreciate that the techniques disclosed herein may be applied in any suitable combination(s). For example, one or more techniques disclosed in any of the following sections may be combined with one or more techniques disclosed in any other section(s), unless they are incompatible. In addition, one or more techniques disclosed in any of the following sections may be combined with one or more techniques disclosed in the same section, unless they are incompatible. Furthermore, the techniques disclosed herein, whether disclosed in different sections or in the same section, may be applied in any suitable order.

### 1. Reporting UE AI/ML Capability

This section defines one or more techniques for addressing question Q1 above:
Q1. How to indicate UE capability of AI/ML to the network (e.g. RAN, CN, another internal and/or external network entity, and/or network function).

For example, the following discloses one or more techniques for reporting UE AI/ML Capability to the Network.

The UE capability for AI/ML operation may be defined and/or reported as:
generic AI/ML capability, or
per use case and/or service AI/ML capability.

The indication of the UE AI/ML capability may be needed at the NG-RAN, CN (e.g. AMF, LMF, and/or other NW entity), or reported to both NG-RAN and CN.

The UE AI/ML capability indication may specify that the UE can perform AI/ML operations (e.g. training, inference, and/or other operations). For example, for the use case of AI/ML for positioning accuracy, the UE capability indication (e.g. capability to use AI/ML for positioning accuracy) may be sent to the NG-RAN, AMF, and/or LMF.

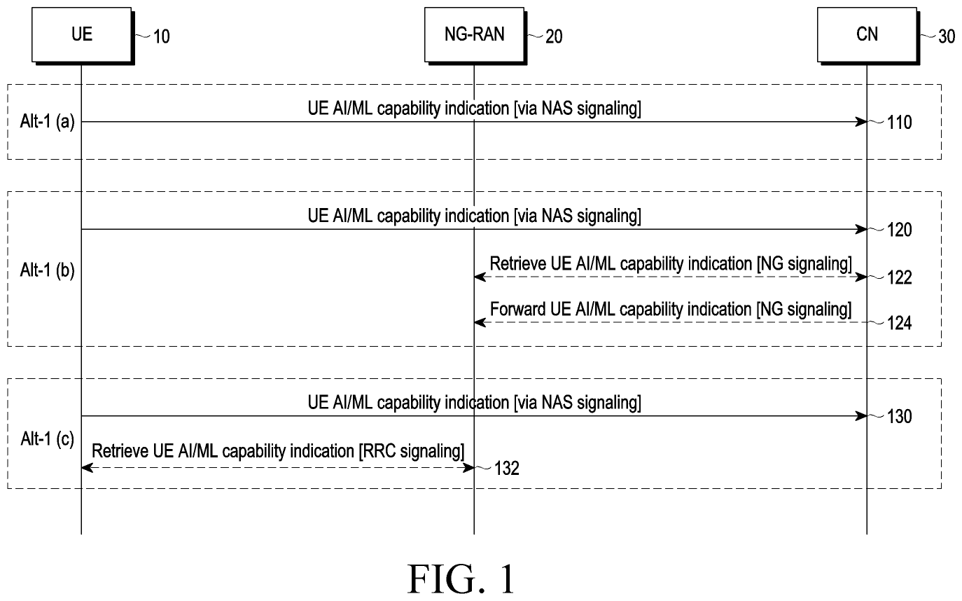

FIG. 1 illustrates two solutions for providing the UE AI/ML capability indication to the NW (e.g. NG-RAN 20 and/or CN 30), as described below:

Alternative 1 (a, b, c): UE AI/ML capability indication to CN 30 using NAS signalling (e.g., NAS signaling 110, 120, or 130)
Alt-1(a):)
The UE AI/ML capability indication may be provided directly from a UE 10 to the CN 30 (e.g. the indication may be transparent to NG-RAN), for example using existing and/or newly defined NAS signalling/messages 110.
Alt-1(b):
The UE AI/ML capability indication may be provided directly from the UE 10 to the CN 30 (e.g. the indication may be transparent to NG-RAN 20), for example using existing and/or newly defined NAS signalling/messages 120.
In certain examples, the CN 30 (e.g. AMF) may forward the UE AI/ML capability indication to NG-RAN 20 (e.g. via existing and/or newly defined NG signalling/messages 124), or,
In certain examples, the NG-RAN 20 may retrieve the UE AI/ML capability indication (and/or any other information related to UE AI/ML capability) from the CN 30 (e.g. via existing and/or newly defined NG signalling/messages 122).
Alt-1(c):
The UE AI/ML capability indication may be provided directly from the UE 10 to the CN 30 (e.g. the indication may be transparent to NG-RAN 20), for example using existing and/or newly defined NAS signalling/messages 130.
In certain examples, the NG-RAN 20 may retrieve UE AI/ML capability indication from the UE 10 (e.g. after AS and NAS security establishment), for example via RRC signalling/messages 132 (e.g. using exiting and/or newly defined signalling/messages).

The UE capability information may be sent in an existing IE (e.g. 5GMM capability IE), and/or in a new IE (e.g. UE Access Network AI-ML capability IE), where this IE may be used to report the UE capability as described above.

In certain examples, the CN (e.g. AMF) may also forward the UE capability information to any other core network node, for example the LMF, SMF, etc.

Alternative 2: UE AI/ML capability indication to NG-RAN 20 using RRC signalling 310, and the NG-RAN 20 forwards the indication to the CN 30 using NG signalling 320

The UE AI/ML capability indication may be provided from the UE 10 to the NG-RAN 20 using an existing and/or newly defined IE (e.g. UE AI/ML Capability IE, UE AI/ML Capability Indication IE, or any other suitable naming), for example via RRC signalling/messages 310 (e.g. using existing and/or newly defined signalling/messages).

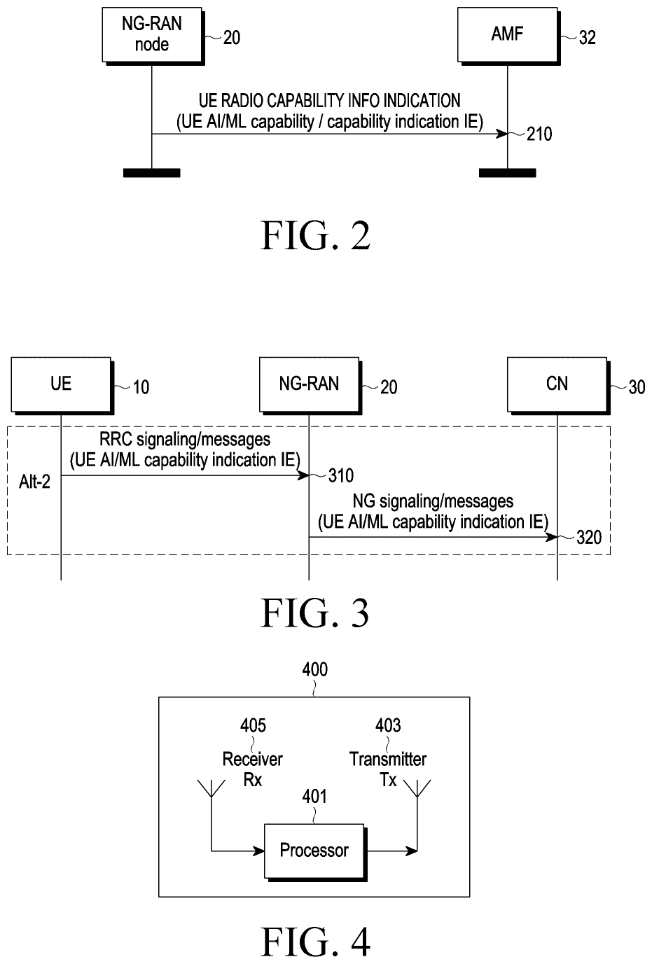

The NG-RAN 20 may send/forward to the CN 30 (e.g. AMF 32) information related to UE AI/ML Capability Indication, using for example:
an existing IE and/or a newly defined IE (e.g. UE AI/ML Capability IE, UE AI/ML Capability Indication IE, or any other suitable naming), for example included in the UE RADIO CAPABILITY INFO INDICATION message 210, as shown in FIG. 2 and Table 1; or
an existing IE and/or a newly defined IE (e.g. UE AI/ML Capability IE, UE AI/ML Capability Indication IE, or any other suitable naming), for example included in newly defined NG signalling/messages 320, as shown in FIG. 3.

The UE capability information may be sent in an existing IE (e.g. 5GMM capability IE), or in a newly defined IE (e.g. UE Access Network AI-ML capability IE), where this IE may be used to report the UE capability as described above.

In certain examples, the CN 30 (e.g. AMF 32) may also forward the UE capability information to any other core network node, for example the LMF, SMF, etc.

Table 1 shows an Example of including “UE AI/ML Capability/Capability Indication IE” in the UE RADIO CAPABILITY INFO INDICATION message (e.g., the message 210).

TABLE 1

| IE/ | | | IE type | | | |
|---|---|---|---|---|---|---|
| Group | | | and | Semantics | | Assigned |
| Name | Presence | Range | reference | description | Criticality | Criticality |
| Message Type | M | | 9.3.1.1 | | YES | ignore |
| AMF UE NGAP ID | M | | 9.3.3.1 | | YES | reject |
| RAN UE NGAP ID | M | | 9.3.3.2 | | YES | reject |
| UE Radio Capability | M | | 9.3.1.74 | | YES | ignore |
| [ . . . ] | | | | | | |
| UE QMC Capability | O | | 9.3.1.226 | | YES | ignore |
| UE AI/ML | O | | 9.3.1.xxx | | YES | ignore |
| Capability/ | | | | | | |
| Capability Indication | | | | | | |

### 2. Reporting Network AI/ML Capability to the UE

This section defines one or more techniques for addressing question Q2 above:
Q2. How to indicate network AI/ML capability to the UE (and/or other network entities and/or functions).

For example, the following discloses one or more techniques for reporting Network AI/ML Capability to the UE.

The network (e.g. NG-RAN, AMF, LMF, and/or any other internal or external entity) may provide one or more of the following items of information related to network AI/ML operation:
(1) Notification of the Network AI/ML Capability (e.g. Network supports AI/ML operation).
(2) List of supported/available AI/ML models in the network.
(3) Other information related to AI/ML models and AI/ML operation in this network (e.g. validity area and/or time of the AI/ML model(s), for example AI/ML model(s) may be available over a given location, cell, TA or a country).

For example,
The network may send one or more of the following items of assistance information to the UE:
(1) The network AI/ML capability,
(1) List of AI/ML models supported/available in the network (or part of the network (e.g. a given area, cell, TA, country, etc.)), and/or
(1) Other information related to AI/ML operation/models (e.g. whether the model is trained (e.g. ready for inference) or requires training).
The network may notify the UE of above assistance information in (1), (2), and/or (3), for example using one or more of:
   Dedicated NAS signalling/messages:
for example, the AMF may provide the information to the UE via NAS signalling/messages.
   LMF may provide the information to the UE, for example in relation to AI/ML models on Location/Positioning using LPP towards the UE.
   Other 5GC entities (e.g. NWDAF, MTLF) may provide the information to AMF/LMF, for example by letting them ‘get ready’ to provide the model availability (e.g. train/federate), however, the same signalling/messages as above (NAS, LPP) may be used towards the UE.
   In certain examples, DCAF (Data Collection Application Function) may be (e.g. additionally) used to indicate information (above) at the UE.
   Dedicated RRC signalling/messages. For example, the NG-RAN may send the assistance information (e.g. info in (1), (2), and/or (3)) using one or more of the following:
An existing IE and/or a newly defined IE: “Network AI/ML Capability IE, Network AI/ML Support IE, AI/ML Support IE, or another named IE”. For example, this IE may be included in an existing or a newly defined RRC message.
System Information Broadcast (e.g. periodically and/or on-demand), for example:
Each cell of the serving NG-RAN node may broadcast, as part of system information, an indication (e.g. 1 bit/flag) that the NG-RAN supports AI/ML operation, for example:)
   “1” NG-RAN supports AI/ML operation
   “0” NG-RAN does not support AI/ML operation)
   For example, the indication bit “1/0” may be included in existing MIB, SIB, and/or a newly defined SIB.

FIG. 4 is a block diagram of an exemplary network entity that may be used in examples of the present disclosure, such as the techniques disclosed in relation to FIGS. 1 to 3. For example, an UE (e.g., the UE 10), AI/ML AF, NEF, UDM, UDR, NF, (R) AN (e.g., the NG-RAN 20), AMF (e.g., the AMF 32), SMF, NWDAF and/or other NFs may be provided in the form of the network entity illustrated in FIG. 4. The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

Referring to FIG. 4, the entity 400 may include a processor (or a controller) 401, a transmitter 403, and a receiver 405. The receiver 405 is configured for receiving one or more messages from one or more other network entities (e.g., the UE 10, the NG-RAN 20, or the CN 30), for example as described above. The transmitter 403 is configured for transmitting one or more messages to one or more other network entities (e.g., the UE 10, the NG-RAN 20, or the CN 30), for example as described above. The processor 401 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

### Acronyms and Definitions

3GPP: 3rd Generation Partnership Project
5G: 5th Generation
5GC: 5G Core
5GMM: 5G Mobility Management
AF: Application Function
AI: Artificial Intelligence
AMF: Access and Mobility management Function
AS: Access Stratum
CN: Core Network
CSI: Channel State Information
DCAF: Data Collection Application Function
eNB: Base Station
gNB: NG Base Station
ID: Identity/Identifier
IE: Information Element
IMEI: International Mobile Equipment Identities
LMF: Location Management Function
LPP: LTE Positioning Protocol
LTE: Long Term Evolution
MIB: Master Information Block
ML: Machine Learning
MT: Mobile Termination
MTLF: Model Training Logical Function
NAS: Non-Access Stratum
NEF: Network Exposure Function
NF: Network Function
NG: Next Generation
NGAP: Next Generation Application Protocol
NLOS: Non-Line-of-Sight
NR: New Radio
NW: Network
NWDAF: Network Data Analytics Function
QMC: QoE Measurement Collection
QoE: Quality of Experience
(R) AN: (Radio) Access Network
RRC: Radio Resource Control
SIB: System Information Block
SIM: Subscriber Identity Module
SMF: Session Management Function
TA: Tracking Area
TE: Terminal Equipment
TS: Technical Specification
UDM: Unified Data Manager
UDR: Unified Data Repository
UE: User Equipment
UL: Uplink

1-15. (canceled)

16. A method for reporting user equipment (UE) artificial intelligence (AI)/machine learning (ML) capability to a network, the method comprising:
transmitting, to the network, an indication of the UE AI/ML capability; and
transmitting as part of the indication, to the network, first information of at least one model ID relating to one or more requested, supported and/or available models, and/or second information relating to one or more model operations including at least one of training, inference, or monitoring.

17. The method of claim 16, wherein the indication is transmitted to one or more of:
a radio access network (RAN) node including at least one of an NG-RAN (new radio generation RAN), a gNB (NG node B), or an eNB (LTE node B) using radio resource control (RRC) signalling and/or messages; or
a core network (CN) entity including at least one of an access and mobility function (AMF), or a location management function (LMF) using non access stratum (NAS) signalling.

18. The method of claim 16, wherein the indication is transmitted or forwarded using an information element (IE) including at least one of a new and/or existing IE, a UE AI/ML Capability IE, a UE AI/ML Capability Indication IE, a IE included in a UE RADIO CAPABILITY INFO INDICATION message, or a IE included in an NG message.

19. The method of claim 16, wherein the first information and/or the second information is transmitted in an information element (IE) of a UE capability indication message, to the network.

20. The method of claim 16, wherein the indication indicates one or more of:
generic AI/ML capability including an indication that the UE can perform AI/ML operations;
per use case AI/ML capability;
per service AI/ML capability including an indication that the UE can use AI/ML for positioning accuracy; or
per AI/ML operation capability.

21. The method of claim 16, wherein the indication indicates that the UE can perform one or more of:
training;
inference;
monitoring;
selection;
switching; or
an operation related to model management.

22. A method for reporting network artificial intelligence (AI)/machine learning (ML) capability to a user equipment (UE), the method comprising:
transmitting, to the UE, an indication of the network AI/ML capability; and
transmitting as part of the indication, to the UE, first information of at least one model ID relating to one or more requested, supported and/or available models, and/or second information relating to one or more model operations including at least one of training, inference, or monitoring.

23. The method of claim 22, wherein the indication is transmitted by one or more of:
a radio access network (RAN) node including at least one of an NG-RAN (new radio generation RAN), a gNB (NG node B) or an eNB (LTE node B): or
a core network (CN) entity including at least one of an access and mobility function (AMF), or a location management function (LMF).

24. The method of claim 23, further comprising:
forwarding, by a first network entity including the AMF, to a second network entity including the LMF and/or a session management function (SMF), the indication.

25. The method of claim 22, wherein the indication indicates one or more of:
generic AI/ML capability including an indication that the network supports AI/ML operations:
a list of supported and/or available AI/ML models in the network:
information of at least one model ID related to one or more AI/ML models and/or one or more AI/ML operations in the network, to indicate whether a model is ready for inference or requires training and/or monitoring:
per AI/ML operation capability: or
per use case AI/ML capability.

26. The method of claim 22, wherein the indication is transmitted using one or more of:
NAS signalling from a CN entity other than LMF: or
LTE positioning protocol (LPP) signalling towards the UE from the LMF.

27. The method of claim 22, wherein the indication is transmitted using one or more of:
dedicated signalling:
an Information Element (IE) included in an RRC message: or
system information broadcast periodically and/or on-demand.

28. The method of claim 27, wherein the method further comprises: broadcasting, as part of system information in a system information block (SIB), by each cell of a serving RAN node, a flag indication indicating that the serving RAN node supports AI/ML operation.

29. A user equipment (UE) for reporting UE artificial intelligence (AI)/machine learning (ML) capability to a network, the UE comprising:
a transmitter; and
a processor,
wherein the processor is configured to:
transmit, to the network, an indication of the UE AI/ML capability; and
transmit as part of the indication, to the network, first information of at least one model ID relating to one or more requested, supported and/or available models, and/or second information relating to one or more model operations including at least one of training, inference, or monitoring.

30. A network entity for reporting network artificial intelligence (AI)/machine learning (ML) capability to a user equipment (UE), the network entity comprising:
a transmitter; and
a processor,
wherein the processor is configured to:
transmit, to the UE, an indication of the network AI/ML capability; and
transmit as part of the indication, to the UE, first information of at least one model ID relating to one or more requested, supported and/or available models, and/or second information relating to one or more model operations including at least one of training, inference, or monitoring.
